(19) United States
(12) Patent Application Publication
(10) Pub. No.: US 2011/0234353 A1
(43) Pub. Date: Sep. 29, 2011

(54) MAGNETIC COMPONENT AND METHOD OF MANUFACTURING THE SAME

(75) Inventor: Kouji FUJIMURA, Kariya-shi (JP)

(73) Assignee: DENSO CORPORATION, Kariya-city (JP)

(21) Appl. No.: 13/074,359

(22) Filed: Mar. 29, 2011

(30) Foreign Application Priority Data
Mar. 29, 2010 (JP) 2010-075368

(51) Int. Cl. H01F 27/255; H01F 41/06

(52) U.S. Cl. 336/83; 29/605

(57) ABSTRACT

A reactor (magnetic component) has a core that constitutes a magnetic circuit of a magnetic flux generated by energizing a coil. The coil has a cylindrical wound part made of a lead wire wound like a cylinder, and a pair of terminals that has both ends of the wound part projected from one end in an axial direction. The pair of terminals is made of a first terminal formed by leading out an end of the lead wire from a first end portion (one end portion in an axial direction) of the wound part, and a second terminal, which penetrates inside the wound part in the axial direction, formed by leading out another end of the lead wire from a second end portion (another end portion in the axial direction) of the wound part.

### CROSS-REFERENCE TO RELATED APPLICATION

This application is based on and claims the benefit of priority from earlier Japanese Patent Application No. 2010-75368 filed Mar. 29, 2010, the description of which is incorporated herein by reference.

### BACKGROUND

The present disclosure relates to a magnetic component that has a coil and a core that constitutes a magnetic circuit of a magnetic flux generated by energizing the coil, and a method of manufacturing the magnetic component.

### DESCRIPTION OF THE RELATED ART

There are known a transformer, a choke coil, and a reactor, etc. as magnetic components that have a coil and a core that constitutes a magnetic circuit of a magnetic flux generated by energizing the coil.

For example, as shown in JP 2008-198981, there is a reactor provided with a cylindrical coil and a core made of a magnetic powder mixed resin that has a magnetic powder such as an iron powder etc. mixed into an insulating resin such as an epoxy resin etc. and distributed so as to surround the coil.

FIG. 14 to FIG. 17 show conventional examples of the magnetic component.

In a magnetic component such as such a reactor, as shown in FIG. 14 and FIG. 15, a coil 92 has a cylindrical wound part 921 made of a lead wire 920 wound like a cylinder, and a pair of terminals 922 and 923 that has both ends of the wound part 921 projected from one end (a first end portion) 921a in an axial direction.

One of the terminals 923 of the pair of the terminals 922 and 923 is formed by leading out the lead wire 920 from another end (a second end portion) 921b of the wound part 921 and passing it outside of the wound part 921.

However, as shown in FIG. 16, the coil 92 is formed by leading out one of the terminals 923 to outside of the wound part 921.

Therefore, there was a problem that the magnetic component with the coil 92 having the above-mentioned composition becomes larger in a radial direction with an amount of the terminal 923 protruding outwardly from the wound part 921.

### SUMMARY

An embodiment provides a magnetic component and a method of manufacturing the same that can achieve miniaturization.

In a magnetic component according to a first aspect, the magnetic component includes a coil, and a core that constitutes a magnetic circuit of a magnetic flux generated by energizing the coil.

The coil has a cylindrical wound part formed by winding a lead wire in a cylinder shape, and a pair of terminals formed by projecting both ends of the lead wire from. one of an end portion of the wound part in an axial direction.

The pair of terminals is made of a first terminal formed by leading out an end of the lead wire from a first end portion of the wound part, and a second terminal, which penetrates inside the wound part in the axial direction, formed by leading out another end of the lead wire from a second end portion of the wound part.

In the magnetic component, one of the pair of the terminals of the coil is the second terminal formed by leading out the other end of the lead wire from the other end portion of the wound part, and making it penetrate inside the wound part in the axial direction.

That is, both the pair of the terminals in the coil is formed inside an outer surface of the wound part without protruding outwardly from the wound part.

Therefore, compared with the conventional case (FIG. 14-FIG. 16) to form the coil with one of the terminals lead outside of the wound part, the size of the coil in the radial direction can be made smaller in an amount protruding outwardly from the wound part.

As a result, the miniaturization of the magnetic component can be achieved.

In the magnetic component according to a second aspect, the first terminal and the second terminal are formed by being lead out from the pair of the end portions of the wound part inside an outer surface of the cylindrical wound part.

In the magnetic component according to a third aspect, the first terminal and the second terminal are projected from the end portion of the wound part in the axial direction so that two main surfaces of the first terminal and the second terminal having largest area that oppose each other face the same direction.

In the magnetic component according to a fourth aspect, the core is made of a magnetic powder mixed resin that is made by mixing a magnetic powder into a insulating resin and distributed, and the coil is laid therein.

In a method of manufacturing a magnetic component according to a fifth aspect, the method has steps of a jig preparation step for preparing a pillar-shaped jig that has an insertion hole formed therein from one end surface toward inside in an axial direction, an inserting step for inserting a lead wire into the insertion hole from an opening of the insertion hole of the jig, a bending step for bending the lead wire from the opening of the insertion hole of the jig in a radial direction, and a winding step for winding the lead wire along an outer surface of the jig in a cylinder shape to a direction away from the first end surface of the jig.

In the method of manufacturing the magnetic component, when the coil is manufactured, the pillar-shaped jig that has the insertion hole is prepared (jig preparation step).

Then, the coil that is the magnetic component can be easily manufactured by sequentially performing the inserting step, the bending step, and the winding step by using the jig.

That is, in the inserting step and the bending step, the part that becomes the second terminal of the coil can be formed by inserting the lead wire into the insertion hole of the jig, and bending it from the opening of the insertion hole in the radial direction.

Next, in the winding step, the part that becomes the wound part of the coil is formed by winding the lead wire 20 along with the outer surface of the jig.

Then, the coil can be easily manufactured from the wound part and the pair of terminals (the first terminal and the second terminal) by forming the first terminal from leading out the lead wire from the first end portion of the wound part.

As a result, the magnetic component that achieves the miniaturization can be obtained by using the coil manufactured by the above-mentioned method.

Thus, the magnetic component and the method of manufacturing the same that achieves the miniaturization can be offered according to the present embodiment.

In the method of manufacturing the magnetic component according to a sixth aspect, a groove part connecting the opening of the insertion hole and the outer surface of the jig is formed on the one end surface of the jig, and the lead wire is bent from the opening of the insertion hole of the jig in the radial direction along with the groove part in the bending step.

In the method of manufacturing the magnetic component according to a seventh aspect, the insertion hole is formed from the one end surface of the jig to a half-way portion of the jig in the axial direction.

### BRIEF DESCRIPTION OF THE DRAWINGS

In the accompanying drawings:

FIG. 1 shows a structure of a reactor in an embodiment;

FIG. 2 shows a top view of the reactor in the embodiment;

FIG. 3 shows a perspective view of a coil in the embodiment;

FIG. 4 shows a sectional view taken along a line A-A in FIG. 3;

FIG. 5 shows a top view of the coil in the embodiment;

FIG. 6 shows a perspective figure of a jig in the embodiment;

FIG. 7 shows a side view of the jig in the embodiment;

FIG. 8 shows a sectional view taken along a line B-B in FIG. 7;

FIG. 9 shows a sectional view of an inserting step in the embodiment;

FIG. 10 shows a sectional view of a bending step in the embodiment;

FIG. 11 shows a sectional view of a winding step in the embodiment;

FIG. 12 shows a sectional view of a detaching the jig in the embodiment;

FIG. 13 shows a sectional view in which a magnetic powder mixed resin is filled in a mold in the embodiment;

FIG. 14 shows a perspective of a conventional coil;

FIG. 15 shows a sectional view taken along a line C-C in FIG. 14;

FIG. 16 shows a top view of the conventional coil; and

FIG. 17 shows a top view of a conventional reactor.

### DETAILED DESCRIPTION OF THE PREFERRED EMBODIMENTS

Magnetic components include a transformer, a choke coil, and a reactor, etc. that have a coil and a core.

Moreover, the core is preferred to be made of a magnetic powder mixed resin that is made by mixing a magnetic powder into an insulating resin and distributed, and the coil is laid therein.

In this case, since the core is not disturbed relative to a shape of the coil, it becomes easy to achieve that a second terminal of a pair of terminals can penetrate in an axial direction inside a wound part.

Moreover, miniaturization of the magnetic component, that is an operation and an effect of the present disclosure, can be effectively demonstrated.

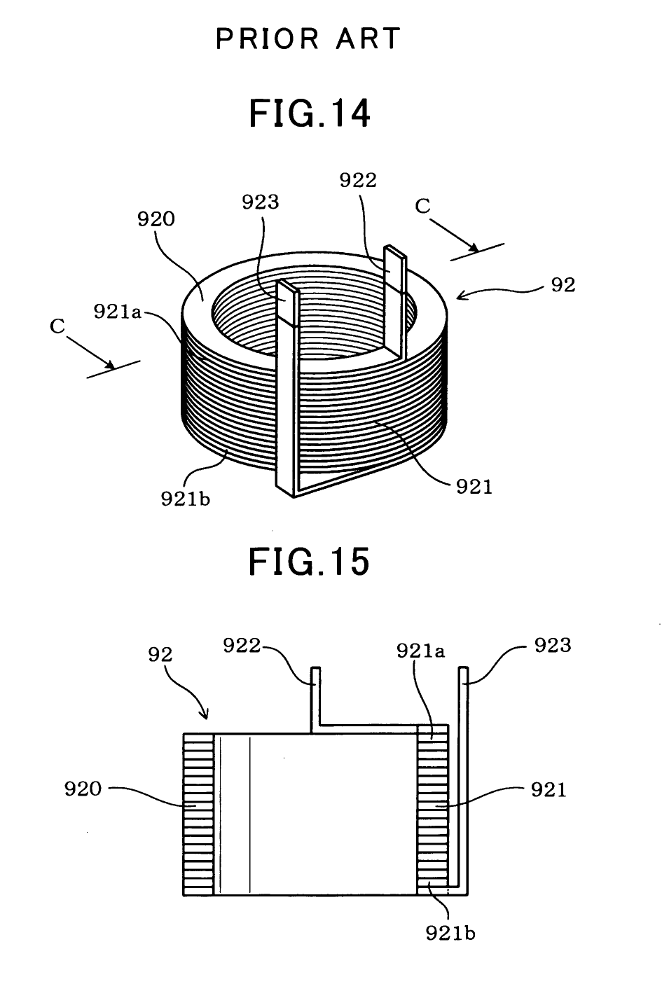

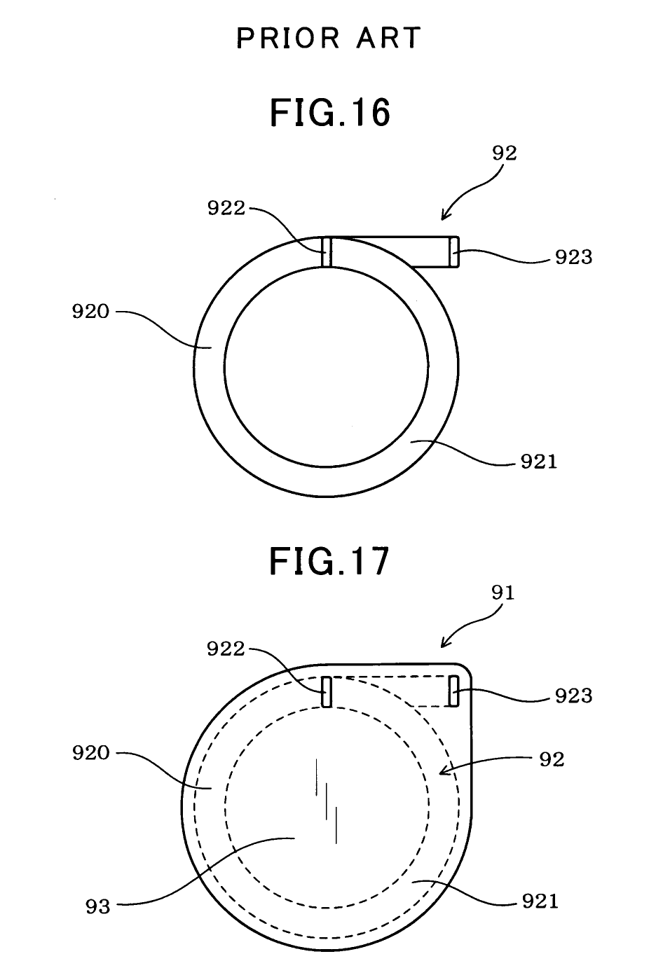

As shown in FIG. 17 for example, when the core 93 is arranged so as to cover the surroundings of the coil 92 by using the coil 92 (FIG. 14-FIG. 16) with a conventional structure in the reactor 91 (magnetic component), it is necessary to form the core 93 to cover another terminal 923 that protrude outwardly from the wound part 921 of the coil 92.

Therefore, there was a problem that size of the reactor (magnetic component) in a radial direction becomes larger since the core 93 could not be formed according to an external shape of the wound part 921 of the coil 92.

Moreover, the core 93 would be formed in the part hardly used as a magnetic circuit like the surroundings of the terminal 923, an extra material cost was required.

However, both the pair of the terminals in the coil are formed by being lead out from the wound part inside an outer surface of the wound part without protruding outwardly from the wound part in the present disclosure.

Therefore, compared with the conventional case (FIG. 17) to use the coil formed with one of the terminals lead outside of the wound part, the part protruding outwardly from the wound part does not need to be covered with the core, thus the core can be formed according to the external shape of the wound part of the coil.

As a result, the size in the radial direction of the coil can be reduced, and the miniaturization of the magnetic component can be achieved.

Moreover, the core is not formed in the part hardly used as a magnetic circuit, and the material cost can be reduced.

In the method of manufacturing the magnetic components, a groove part connecting an opening of an insertion hole and an outer surface of a jig is formed on one end surface in an axial direction of the jig. In a bending step, it is preferred to bend a lead wire from the opening of the insertion hole of the jig in a radial direction along with the groove part.

In this case, the lead wire can be easily bent from the opening of the insertion hole of the jig toward the outer side of the jig.

Moreover, it is preferred that the insertion hole of the jig is formed from one end surface in the axial direction of the jig to a half-way portion of the jig in the axial direction.

In this case, a length of the lead wire inserted in the insertion hole can be constantly adjusted by inserting the lead wire in the insertion hole of the jig and make it touch a bottom of the insertion hole in an inserting step.

Here, the part inserted in the insertion hole of the jig finally becomes the second terminal of the coil among the lead wire.

Therefore, the difference of the final length of the second terminal can be reduced, and can improve a yield rate of materials.

With reference to the drawings, hereinafter will be described an embodiment of the present disclosure.

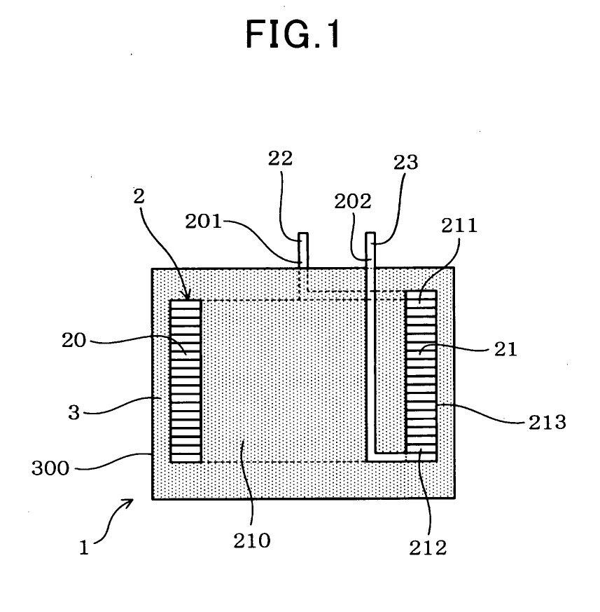

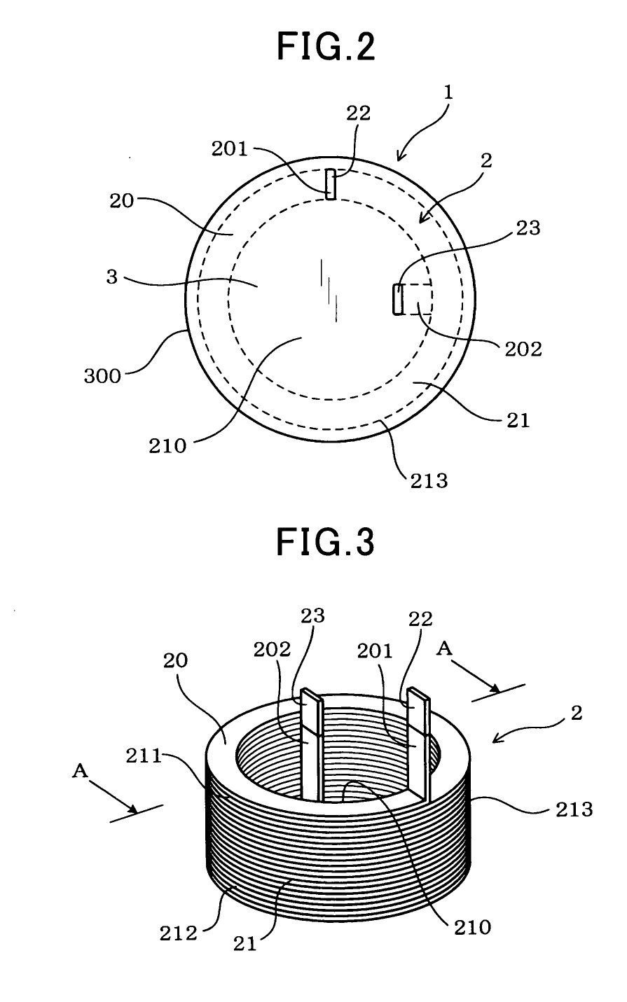

As shown in FIG. 1 and FIG. 2, a magnetic component of the present embodiment is a reactor 1 used for a power converter etc. such as an inverter for a vehicle, and is provided with a coil 2 and a core 3 that constitutes a magnetic circuit of a magnetic flux generated by energizing the coil 2.

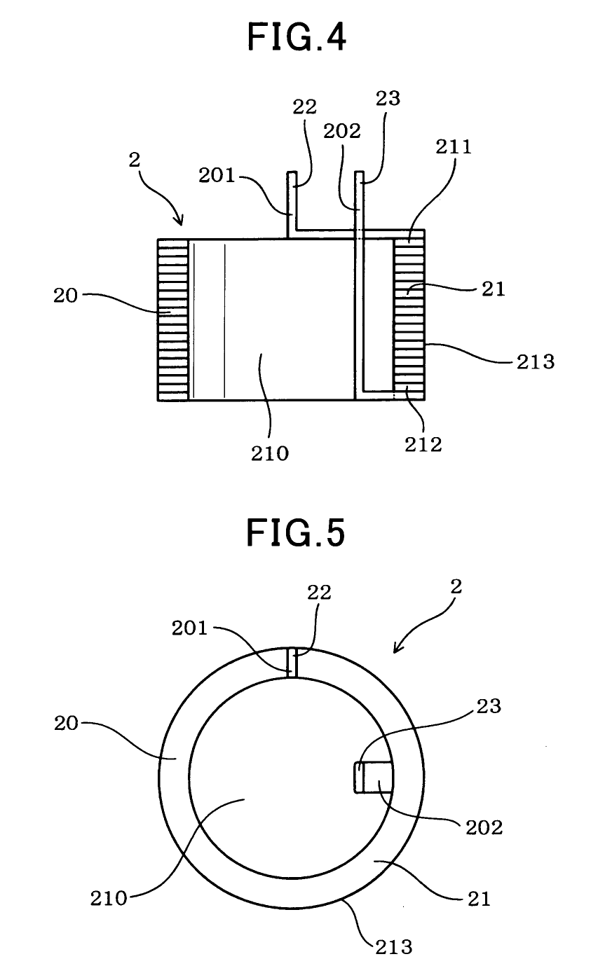

As shown in FIG. 3 and FIG. 4, a coil 2 has a cylindrical wound part 21 formed by winding a flat copper wire that becomes a lead wire 20 in a cylinder shape, and a pair of terminals (a first terminal 22 and a second terminal 23) formed by projecting both ends 201 and 202 of the lead wire 20 from one of an end portion (a first end portion) 211 in an axial direction of the wound part 21.

As shown in the same figures, the first terminal 22 is formed by projecting one end 201 of the lead wire 20 from the first end portion 211 of the wound part 21 in the axial direction.

Moreover, the second terminal 23 is formed by leading another end 202 of the lead wire 20 from another end portion (a second end portion) 212 in the axial direction of the wound part 21 to inside the wound part 21, and penetrating the other end 202 into a hollow portion 210 formed inside the wound part 21 in the axial direction.

Furthermore, the first terminal 22 and the second terminal 23 are projected from the end portion of the wound part 21 in the axial direction so that two main surfaces of the first terminal 22 and the second terminal 23 having largest area that oppose each other face the same direction.

As shown in FIG. 5, a shape of an outer surface 213 of the wound part 21 is a circular shape when the coil 2 is seen from top. That is, the outer shape of the whole coil 2 is circular.

As shown in FIG. 1 and FIG. 2, the core 3 is made of a magnetic powder mixed resin that has an iron powder as a magnetic powder mixed into a thermosetting resin such as an epoxy resin as an insulating resin, and the coil 2 is laid therein.

That is, the core 3 is arranged to cover the surroundings of the coil 2 including the hollow portion 210 inside the wound part 21.

As shown in FIG. 2, a shape on an outer surface 300 of the core 3 is a circular shape along a shape of the outer surface 213 of the wound part 21 of the coil 2 when seen from the top.

Next, the method of manufacturing the reactor 1 (magnetic component) of the present embodiment is explained.

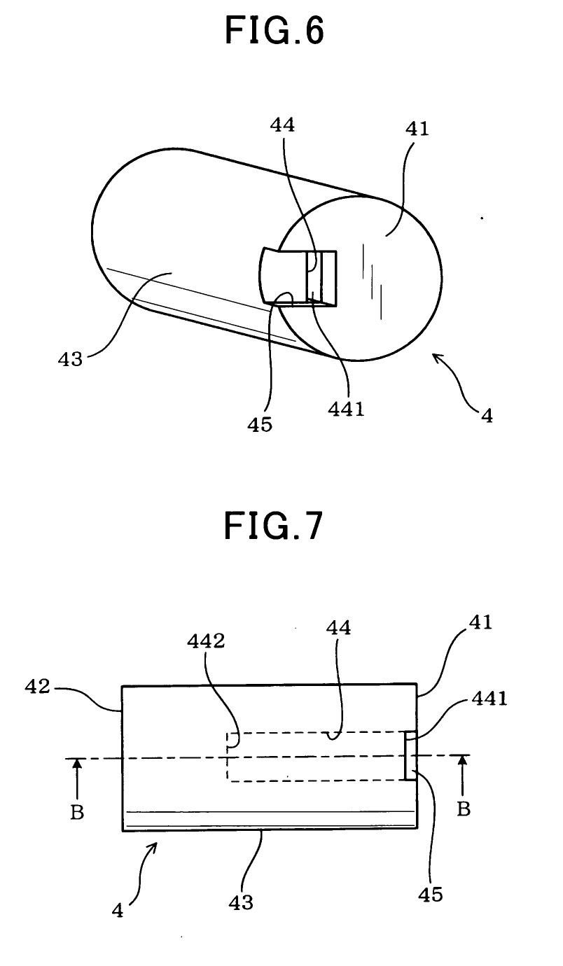

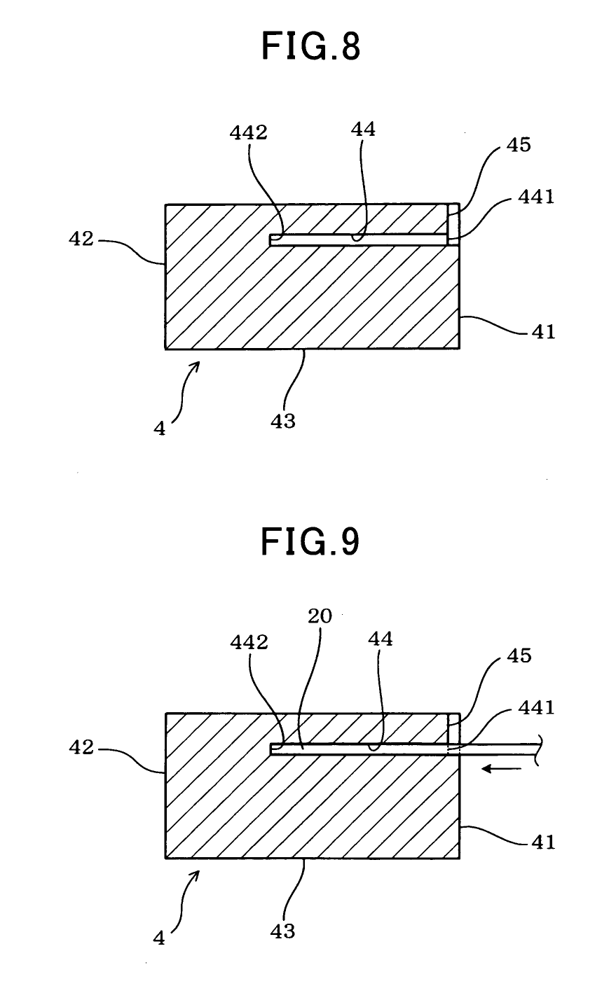

In the method of manufacturing the reactor 1 in the present embodiment, as shown in FIG. 6-FIG. 11, a method of manufacturing the coil 2 has following steps: a jig preparation step for preparing a pillar-shaped jig 4 that has an insertion hole 44 formed therein from one end surface 41 (a first end surface) toward inside in an axial direction; an inserting step for inserting the lead wire 20 into the insertion hole 44 from an opening 441 of the insertion hole 44 of the jig 4; a bending step for bending the lead wire 20 from the opening 441 of the insertion hole 44 of the jig 4 in a radial direction; and a winding step for winding the lead wire 20 along an outer surface 43 of the jig 4 in a cylinder shape to a direction away from the first end surface 41 of the jig 4.

Hereafter, details are explained.

First of all, as shown in FIG. 6-FIG. 8, the jig 4 for manufacturing the coil 2 is prepared. The jig 4 has a columnar shape with the insertion hole 44 formed from the first end surface 41 toward inside in the axial direction.

The insertion hole 44 is formed from the first end surface 41 of the jig 4 to a half-way portion of the jig in the axial direction.

The insertion hole 44 may be formed so that it penetrates to another end surface 42 of the jig 4 (a second end surface).

Moreover, a groove part 45 connecting the opening 441 of the insertion hole 44 and the outer surface 43 of the jig 4 is formed on the first end surface 41 of the jig 4.

Next, as shown in FIG. 9, the lead wire 20 is inserted from the opening 441 of the insertion hole 44 of the jig 4 into the insertion hole 44.

At this time, the lead wire 20 is inserted until a tip of the lead wire 20 touches a bottom 442 of the insertion hole 44 of the jig 4.

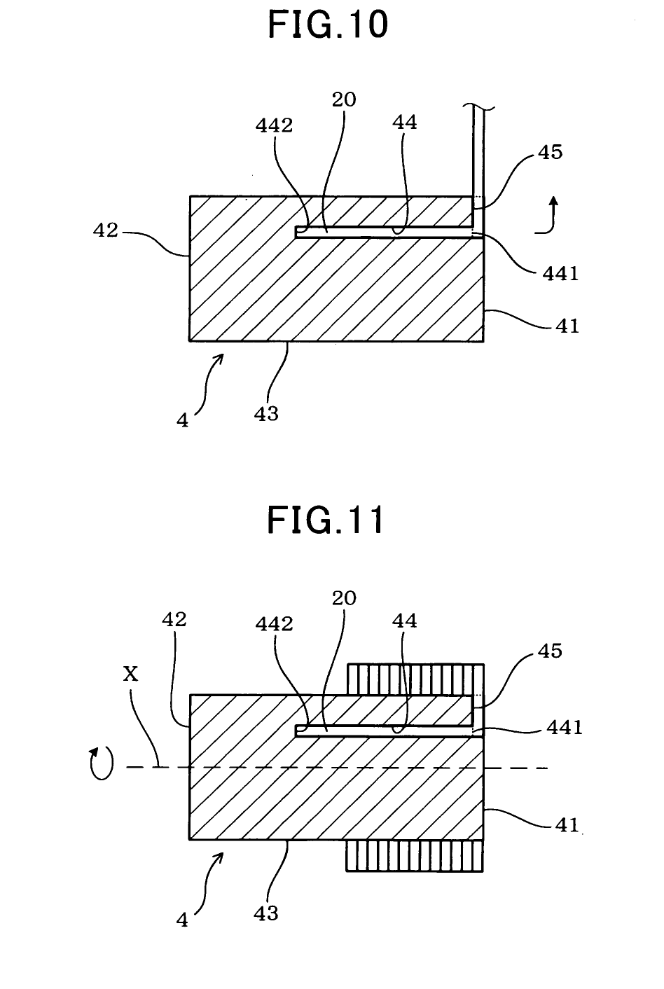

Next, as shown in FIG. 10, the lead wire 20 is bent from the opening 441 of the insertion hole 44 of the jig 4 in the radial direction. At this time, the lead wire 20 is bent from the opening 441 of the insertion hole 44 of the jig 4 in the radial direction along with the groove part 45.

By this, a part that finally becomes the second terminal 23 of the coil 2 is formed.

Next, as shown in FIG. 11, the lead wire 20 is wound in the cylinder shape along with the outer surface 43 of the jig 4 in the direction away from the first end surface 41 the jig 4, i.e., toward the second end surface 42.

In the present embodiment, the lead wire 20 is wound on the outer surface 43 of the jig 4 by spinning the jig 4 with an axis X of the jig 4 as a center.

By this, a part that finally becomes the wound part 21 of the coil 2 is formed.

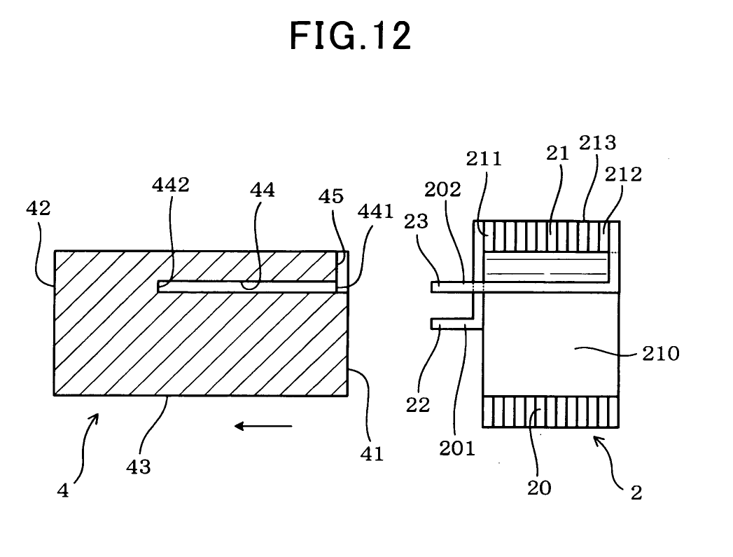

Next, as shown in FIG. 12, the jig 4 is detached from the wound part 21 formed by winding the lead wire 20, and the coil 2 (FIG. 3-FIG. 5) is formed from the wound part 21 and the pair of the terminals (the first terminal 22 and the second terminal 23) by forming the first terminal 22 by leading out the lead wire 20 from the first end portion 211 of the wound part 21.

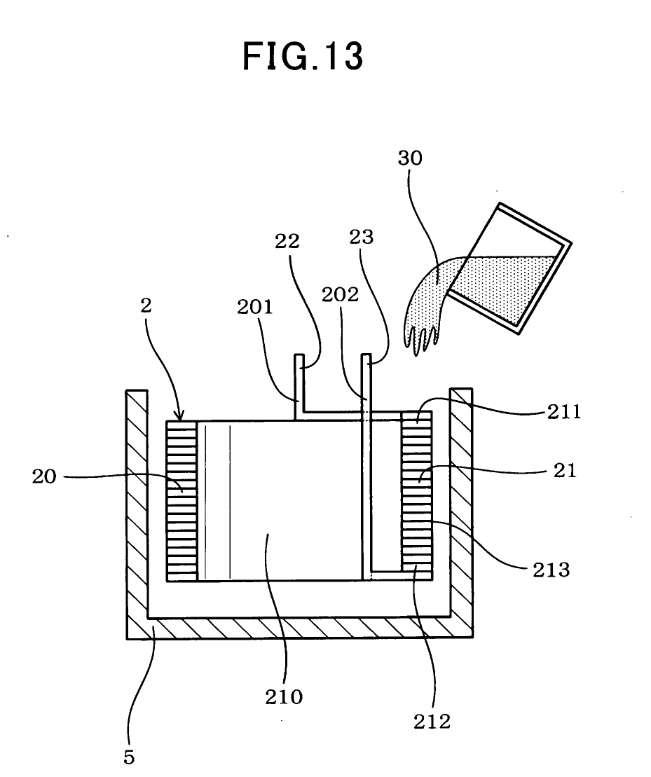

Next, as shown in FIG. 13, the coil 2 is laid in the magnetic powder mixed resin 30 by filling the liquid-conditioned magnetic powder mixed resin 30 into a mold 5 after the coil 2 is placed therein.

Then, the core 3 is formed by applying heat-treatment to the magnetic powder mixed resin 30 to harden the resin.

Next, the reactor 1(Fig. 1 and FIG. 2) that is made of the coil 2 and the core 3 is obtained by detaching the mold 5 from the unitized coil 2 and the core 3.

Next, operation and effect of the reactor (magnetic component) 1 and the method of manufacturing the same in the present embodiment is explained.

In the reactor 1 of the present embodiment, one of the pair of the terminals 22 and 23 of the coil 2 is the second terminal 23 formed by leading out the other end 202 of the lead wire 20 from the second end portion 212 of the wound part 21, and make it penetrate inside the wound part 21 in the axial direction.

That is, both the pair of the terminals 22 and 23 in the coil 2 is formed inside an outer surface 213 of the wound part 21 without protruding outwardly from the wound part 21.

Therefore, compared with the conventional case (FIG. 14-FIG. 16) to form the coil with one of the terminals lead outside of the wound part, the size of the coil 2 in the radial direction can be made smaller in an amount protruding outwardly from the wound part 21.

As a result, the miniaturization of the reactor 1 can be achieved.

Moreover, the core 3 is made of the magnetic powder mixed resin that is made by mixing the magnetic powder into the insulating resin and distributed, and the coil 2 is laid therein in the present embodiment.

Therefore, since the core 3 is not disturbed relative to a shape of the coil 2, it becomes easy to achieve that the second terminal 23 of the pair of terminals 22 and 23 can penetrate in the axial direction inside the wound part 21.

Moreover, because of the structure in which the core 3 is arranged to cover the surroundings of the coil 2, the operation and the effect of the present embodiment that is to miniaturize the reactor 1 can be effectively demonstrated.

That is, compared with the conventional case (FIG. 17) to use the coil formed with one of the terminals lead outside of the wound part, the part protruding outwardly from the wound part 21 is not need to be covered with the core 3, thus the core 3 can be formed according to the external shape of the wound part 21 of the coil 3.

As a result, the size in the radial direction of the coil 2 can be reduced, and the miniaturization of the magnetic component can be achieved.

Moreover, the core 3 is not formed in the part hardly used as a magnetic circuit, and the material cost can be reduced.

Moreover, in the method of manufacturing the reactor of the present embodiment, when the coil 2 is manufactured, the pillar-shaped jig 4 that has the insertion hole 44 is prepared (jig preparation step).

Then, the coil 2 can be easily manufactured by sequentially performing the inserting step, the bending step, and the winding step by using the jig 4.

That is, in the inserting step and the bending step, the part that becomes the second terminal 23 of the coil 2 can be formed by inserting the lead wire 20 into the insertion hole 44 of the jig 4, and bending it from the opening 441 of the insertion hole 44 in the radial direction.

Next, in the winding step, the part that becomes the wound part 21 of the coil 2 is formed by winding the lead wire 20 along with the outer surface 43 of the jig 4.

Then, the coil 2 can be easily manufactured from the wound part 21 and the pair of terminals (the first terminal and the second terminal 23) by forming the first terminal 22 from leading out the lead wire 20 from the first end portion 211 of the wound part 21.

As a result, the reactor 1 that achieves the miniaturization can be obtained by using the coil 2 manufactured by the above-mentioned method.

Moreover, in the method of manufacturing in the present embodiment, the groove part 45 connected from the opening 441 of the insertion hole 44 with the outer surface 43 of the jig 4 is formed on the first end surface 41 of the jig 4, and the lead wire 20 is bent from the opening 441 of the insertion hole 44 of the jig 4 in the radial direction along with the groove part 45 in the bending step.

Therefore, the lead wire 20 can be easily bent from the opening 441 of the insertion hole 44 of the jig 4 toward the outer surface 43 of the jig 4.

Moreover, the insertion hole 44 of the jig 4 is formed from the first end surface 41 of the jig 4 to the half-way portion of the jig in the axial direction.

Therefore, the length of the lead wire 20 inserted in the insertion hole 44 can be constantly adjusted by inserting the lead wire 20 in the insertion hole 44 of the jig 4 and make it touches a bottom 442 of the insertion hole 44 in the inserting step.

Here, the part inserted in the insertion hole 44 of the jig 4 finally becomes the second terminal 23 of the coil 2 among the lead wire 20.

Therefore, the difference of the final length of the second terminal 23 of the coil 2 can be reduced, and can improve a yield rate of materials.

Thus, the reactor (magnetic component) 1 and the method of manufacturing the same that achieves the miniaturization can be offered according to the present embodiment.

It should be appreciated that although the reactor is used as an example of the magnetic component in the present embodiment, it is possible to apply the present disclosure to a transformer, a choke coil, and other magnetic component similarly.

What is claimed is:

1. A magnetic component comprising:
a coil, and
a core that constitutes a magnetic circuit of a magnetic flux generated by energizing the coil,
wherein, the coil has a cylindrical wound part formed by winding a lead wire in a cylinder shape, and a pair of terminals formed by projecting both ends of the lead wire from one of an end portion of the wound part in an axial direction,
the pair of terminals is made of a first terminal formed by leading out an end of the lead wire from a first end portion of the wound part, and a second terminal, which penetrates inside the wound part in the axial direction, formed by leading out another end of the lead wire from a second end portion of the wound part.

2. The magnetic component according to claim 1,
wherein, the first terminal and the second terminal are formed by being lead out from the pair of the end portions of the wound part inside an outer surface of the cylindrical wound part.

3. The magnetic component according to claim 1,
wherein, the first terminal and the second terminal are projected from the end portion of the wound part in the axial direction so that two main surfaces of the first terminal and the second terminal having largest area that oppose each other face the same direction.

4. The magnetic component according to claim
wherein, the core is made of a magnetic powder mixed resin that is made by mixing a magnetic powder into a insulating resin and distributed, and the coil is laid therein.

5. A method of manufacturing a magnetic component comprising:
a jig preparation step for preparing a pillar-shaped jig that has an insertion hole formed therein from one end surface toward inside in an axial direction;
an inserting step for inserting a lead wire into the insertion hole from an opening of the insertion hole of the jig;
a bending step for bending the lead wire from the opening of the insertion hole of the jig in a radial direction; and
a winding step for winding the lead wire along an outer surface of the jig in a cylinder shape to a direction away from the first end surface of the jig.

6. the method of manufacturing the magnetic component according to claim 5,
wherein, a groove part connecting the opening of the insertion hole and the outer surface of the jig is formed on the one end surface of the jig, and
the lead wire is bent from the opening of the insertion hole of the jig in the radial direction along with the groove part in the bending step.

7. the method of manufacturing the magnetic component according to claim 5,
wherein, the insertion hole is formed from the one end surface of the jig to a half-way portion of the jig in the axial direction.
